(19) United States
(12) Patent Application Publication
(10) Pub. No.: US 2026/0290812 A1
(43) Pub. Date: Sep. 24, 2026

(54) CATHODE ACTIVE MATERIAL

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/569,804

(22) Filed: Mar. 17, 2026

(30) Foreign Application Priority Data
Mar. 21, 2025 (JP) 2025-046340

(51) Int. Cl. H01M 4/525; C01G 53/506; H01M 4/02; H01M 4/36

(52) U.S. Cl. CPC H01M 4/525; C01G 53/506; H01M 4/366; C01P 2002/50; C01P 2002/85; C01P 2004/04; C01P 2006/40; H01M 2004/028

(57) ABSTRACT

Provided is a cathode active material configured to decrease the rate of resistance increase that is due to battery charge and discharge, the cathode active material having, in TEM-EDX analysis, a first peak in a range of 690 ev or more and 700 ev or less and a second peak in a range of 640 ev or more and 650 ev or less, and the cathode active material comprising a Mn element that is derived from the second peak.

### TECHNICAL FIELD

The disclosure relates to a cathode active material.

### BACKGROUND

Various studies have been proposed for cathode active materials as disclosed in Patent Documents 1 to 3.
Patent Document 1: Japanese Patent Application Laid-Open (JP-A) No. 2021-114411
Patent Document 2: Japanese translation of PCT international application No. 2021-509764
Patent Document 3: JP-A No. 2010-135207

Various cathode active materials have been proposed for obtaining cathodes that have high battery characteristics such as high cycle characteristics and high output characteristics.

When used in batteries, Mn-containing cathode active materials have room for improvement in the rate of resistance increase that is due to battery charge and discharge.

### SUMMARY

The present disclosure was achieved in light of the above circumstances. An object of the present disclosure is to provide a cathode active material configured to decrease the rate of resistance increase that is due to battery charge and discharge.

The present disclosure includes the following embodiments.
<1> A cathode active material,
wherein, in TEM-EDX analysis, the cathode active material has a first peak in a range of 690 ev or more and 700 ev or less and a second peak in a range of 640 ev or more and 650 ev or less, and
wherein the cathode active material comprises a Mn element that is derived from the second peak.
<2> The cathode active material according to the above 1>,
wherein, when a region between a surface of the cathode active material and a predetermined depth T from the surface of the cathode active material toward a center thereof, is considered as a surface layer, and a region between the predetermined depth T and the center is considered as a central layer,
in the TEM-EDX analysis, the surface layer has the first and second peaks which a peak intensity of the first peak is larger than that of the second peak and which an amount of an element derived from the first peak is larger than that of the Mn element derived from the second peak, and
in the TEM-EDX analysis, the central layer has the first and second peaks which the peak intensity of the second peak is larger than that of the first peak and which the amount of the Mn element derived from the second peak is larger than that of the element derived from the first peak.
<3> The cathode active material according to the above <1>,
wherein, when a region between a surface of the cathode active material and a predetermined depth T from the surface of the cathode active material toward a center thereof, considered as a surface layer, and a region between the predetermined depth T and the center is considered as a central layer,
in the TEM-EDX analysis, the surface layer has the first peak, is free of the second peak and is free of the Mn element derived from the second peak, and
in the TEM-EDX analysis, the central layer has the second peak, is free of the first peak and is free of an element derived from the first peak.
<4> The cathode active material according to the above <1>,
wherein, when a region between a surface of the cathode active material and a predetermined depth T1 from the surface of the cathode active material toward a center thereof, a region between the predetermined depth T1 and a predetermined depth T2, a region between the predetermined depth T2 and a predetermined depth T3, and a region between the predetermined depth T3 and the center are considered as a first surface layer, a second surface layer, a first central layer and a second central layer, respectively,
in the TEM-EDX analysis, the first surface layer has the first peak, is free of the second peak and is free of the Mn element derived from the second peak;
in the TEM-EDX analysis, the second surface layer has the first and second peaks which a peak intensity of the first peak is larger than that of the second peak and which an amount of an element derived from the first peak is larger than that of the Mn element derived from the second peak;
in the TEM-EDX analysis, the first central layer has the first and second peaks which the peak intensity of the second peak is larger than that of the first peak and which the amount of the Mn element derived from the second peak is larger than that of the element derived from the first peak; and
in the TEM-EDX analysis, the second central layer has the second peak, is free of the first peak and is free of the element derived from the first peak.
<5> The cathode active material according to any one of the above <1> to <4>, further comprising a Li element, a Ni element and a Co element.
<6> The cathode active material according to the above <5>, wherein a content of the Mn in the cathode active material is 0.1 mol with respect to 1 mol that is a total of the Ni, Co and Mn contained in the cathode active material.
<7> A cathode layer comprising the cathode active material defined by any one of the above <1> to <6>.
<8> A battery comprising a cathode layer comprising the cathode active material defined by any one of the above <1> to <6>.
<9> A method for producing the cathode active material defined by any one of the above <1> to <6>, the method comprising:
a first sintering step of obtaining a precursor of the cathode active material by sintering a first mixture of a transition metal hydroxide and a lithium compound at a temperature of from 700° C. to 1100° C.,
a spray-drying step of obtaining a dried product by spray-drying a second mixture of the precursor of the cathode active material and Mn(NO₃)₂ with a spray dryer, and
a second sintering step of obtaining the cathode active material by sintering the dried product at a temperature of from 100° C. to 130° C.,
wherein an air inlet temperature of the spray dryer in the spray-drying step is from 100° C. to 130° C.

According to the present disclosure, a cathode active material configured to decrease the rate of resistance increase that is due to battery charge and discharge, is provided.

### BRIEF DESCRIPTION OF THE DRAWINGS

In the accompanying drawings,

FIG. 1 is a schematic view of an example of the structure of the cathode active material of the present disclosure;

FIG. 2 is a schematic view of another example of the structure of the cathode active material of the present disclosure; and

FIG. 3 shows a spectrum of the cathode active material of Example 1 obtained by TEM-EDX.

### DETAILED DESCRIPTION

Hereinafter, the embodiments of the present disclosure will be described in detail. Matters that are required to implement the present disclosure (such as common structures and production processes of cathode active materials not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relations (such as length, width and thickness) in the drawings do not reflect actual dimensional relations.

In the present disclosure, unless otherwise noted, a singular noun may encompass a plural noun. For example, the word “particle” may encompass “particles” (a group of particles).

In the present disclosure, an example of the method for calculating the average particle diameter of particles is as follows. First, for a particle shown in an image taken at an appropriate magnification (e.g., 50,000× to 1,000,000×) with a transmission electron microscope (hereinafter referred to as TEM) or a scanning electron microscope (hereinafter referred to as SEM), the diameter when the particle is considered spherical, is calculated. Such a particle diameter calculation by TEM or SEM observation is carried out on 2 to 300 particles of the same type, and the average of the diameters of the particles is determined as the average particle diameter.

### 1. Cathode Active Material

According to the present disclosure, a cathode active material is provided,
wherein, in TEM-EDX analysis, the cathode active material has a first peak in a range of 690 ev or more and 700 ev or less and a second peak in a range of 640 ev or more and 650 ev or less, and
wherein the cathode active material comprises a Mn element that is derived from the second peak.

In the present disclosure, since the first and second peaks appear in the TEM-EDX analysis of the cathode active material, elution of the Mn element from the cathode active material which is due to battery charge and discharge, can be suppressed, and an increase in battery resistance can be suppressed. This is thought to be because the element derived from the first peak is more stable than the Mn element derived from the second peak. Since the element derived from the first peak is present near the surface of the cathode active material, the elution of the Mn element from the cathode active material can be more suppressed.

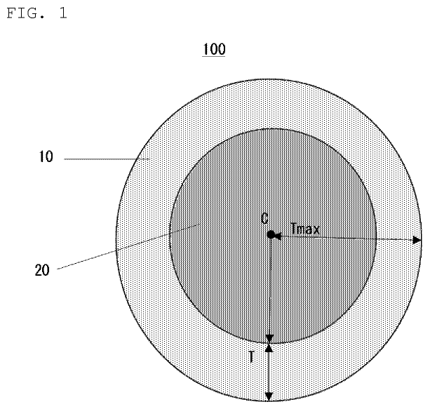

FIG. 1 is a schematic view of an example of the structure of the cathode active material of the present disclosure. As shown in FIG. 1, a cathode active material 100 that is the cathode active material of the present disclosure includes a surface layer 10 and a central layer 20. The surface layer 10 is the region between the surface of the cathode active material 100 and a predetermined depth T from the surface of the cathode active material 100 toward the center C thereof. The central layer 20 is the region between the predetermined depth T and the center C.

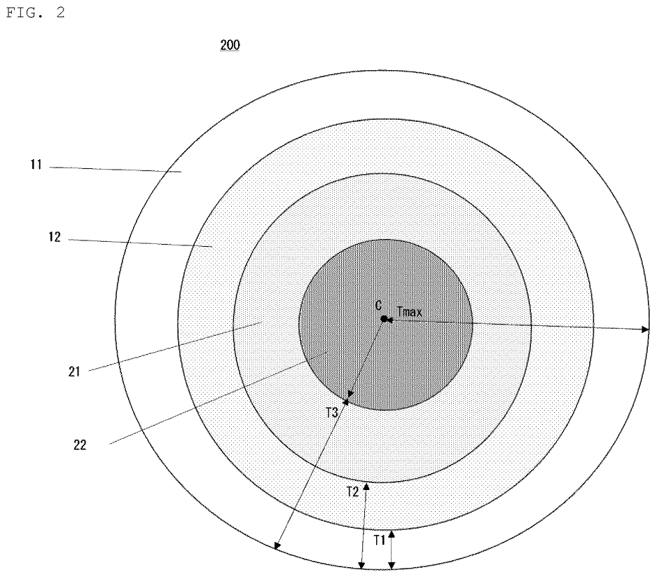

FIG. 2 is a schematic view of another example of the structure of the cathode active material of the present disclosure. As shown in FIG. 2, a cathode active material 200 that is the cathode active material of the present disclosure includes a first surface layer 11, a second surface layer 12, a first central layer 21 and a second central layer 22. The first surface layer 11 is the region between the surface of the cathode active material 200 and a predetermined depth T1 from the surface of the cathode active material 200 toward the center C thereof. The second surface layer 12 is the region between the predetermined depth T1 from the surface of the cathode active material 200 and a predetermined depth T2 from the surface of the cathode active material 200. The first central layer 21 is the region between the predetermined depth T2 from the surface of the cathode active material 200 and a predetermined depth T3 from the surface of the cathode active material 200. The second central layer 22 is the region between the predetermined depth T3 from the surface of the cathode active material 200 and the center C of the cathode active material 200.

In TEM-EDX analysis, the cathode active material has the first peak in a range of 690 ev or more and 700 ev or less and the second peak in a range of 640 ev or more and 650 ev or less.

The presence or absence of the first and second peaks can be confirmed by the following method. In the TEM-EDX analysis, a peak that is observed in a range of 610 ev or more and 630 ev or less is considered as a reference peak. When the peak intensity of the first peak is higher than that of the reference peak, the first peak is considered to be present. When the peak intensity of the second peak is higher than that of the reference peak, the second peak is considered to be present.

The first peak may be a peak derived from Mn(NO₃)₂. For example, the element derived from the first peak (hereinafter may be referred to as “element Q”) may be an element derived from Mn(NO₃)₂, may be a Mn element, or may be an impurity element other than a Mn element. As the impurity element, examples include, but are not limited to, a F element. That is, the element Q may be at least one selected from the group consisting of a Mn element and a F element.

The second peak may be the peak of a Mn element derived from Mn2p3 in lithium nickel cobalt manganate. In lithium nickel cobalt manganate, Mn is mainly present in the crystal structure form of LiMnO₂, and a part thereof may be in another form such as Li₂MnO₃, MnO₂, Mn₂O₃ and Mno.

The crystal structure of the compound containing the element derived from the first peak may be different from the crystal structure of the compound containing the Mn element derived from the second peak.

When the element derived from the first peak is Mn, the valence of the Mn element derived from the first peak may be larger than that of the Mn element derived from the second peak.

The cathode active material contains at least the Mn element derived from the second peak.

### First Embodiment

The cathode active material may have a single-layered structure consisting of a Mn-containing layer that contains the element derived from the first peak and the Mn element derived from the second peak. In the cathode active material, the amount of the element derived from the first peak may be smaller than that of the Mn element derived from the second peak.

### Second Embodiment

The cathode active material may have a two-layered structure consisting of the surface layer and the central layer.

The surface layer is the region between the surface of the cathode active material and the predetermined depth T from the surface of the cathode active material toward the center thereof.

In the TEM-EDX analysis, the surface layer has the first and second peaks which the peak intensity of the first peak is larger than that of the second peak and which the amount of the element derived from the first peak is larger than that of the Mn element derived from the second peak.

In the TEM-EDX analysis, the surface layer has the first peak, may be free of the second peak, contains the element derived from the first peak, and may be free of the Mn element derived from the second peak.

The surface layer may be free of the Ni element and the Co element.

The outermost surface of the surface layer may be a point where the first peak is observed first when the TEM-EDX line analysis of the cathode active material is performed from the surface of the cathode active material toward the center thereof.

The central layer is the region between the predetermined depth T and center of the cathode active material. When the point of the predetermined depth T of the cathode active material corresponds to the surface layer, the central layer does not include the point of the predetermined depth T of the cathode active material.

In the TEM-EDX analysis, the central layer has the first and second peaks which the peak intensity of the second peak is larger than that of the first peak and which the amount of the element derived from the first peak is smaller than that of the Mn element derived from the second peak.

In the TEM-EDX analysis, the central layer has the second peak, may be free of the first peak, contains the Mn element derived from the second peak, and may be free of the element derived from the first peak.

The central layer may contain at least one selected from the group consisting of the Ni element and the Co element.

The outermost surface of the central layer may be a point where the peak intensity of the second peak is larger than that of the first peak first when the TEM-EDX line analysis of the cathode active material is performed from the surface of the cathode active material toward the center thereof, or it may be a point where the second peak is observed and the first peak is not observed first when the TEM-EDX line analysis of the cathode active material is performed from the surface of the cathode active material toward the center thereof.

The predetermined depth T from the surface of the cathode active material may be half or less the depth Tmax from the surface of the cathode active material, may be a depth of more than 0 nm and 0.9 nm or less from the surface of the cathode active material toward the center thereof, or may be a depth of 0.9 nm from the surface of the cathode active material toward the center thereof, for example. As for the ratio (T/Tmax) of the predetermined depth T from the surface of the cathode active material to the depth Tmax from the surface of the cathode active material, the lower limit may be more than 0, may be 0.001 or more, may be 0.0036 or more, may be 0.0072 or more, may be 0.0144 or more, may be 0.02 or more, or may be 0.03 or more, and the upper limit may be 0.5 or less, may be 0.3 or less, may be 0.2 or less, or may be 0.1 or less.

In the second embodiment, the cathode active material may include the central layer containing the Mn element derived from the second peak and the surface layer (coating layer) containing the element derived from the first peak and coating the surface of the central layer.

The coating layer may be a layer containing Mn(NO₃)₂, or it may be a layer consisting of Mn(NO₃)₂.

For example, the coating layer can be confirmed by compositional analysis (elemental analysis) of a TEM image, which is obtained by the TEM observation, by energy dispersive X-ray spectrometry (EDX). The compositional analysis can be carried out by a known method such as TEM-EDX, SEM-EDX and X-ray photoelectron spectroscopy (XPS).

The thickness of the coating layer is not particularly limited. For example, the lower limit of the thickness of the coating layer may be 0.5 nm or more, 1 nm or more, or 3 nm or more, and the upper limit of the thickness of the coating layer may be 20 nm or less, 15 nm or less, 10 nm or less, or 5 nm or less. The thickness of the coating layer is obtained as the average of the thicknesses of at least 5 points of the coating layer measured in the TEM observation of the cathode active material.

### Third Embodiment

The cathode active material may have a four-layered structure consisting of the first surface layer, the second surface layer, the first central layer and the second central layer.

The first surface layer is the region between the surface of the cathode active material and the predetermined depth T1 from the surface of the cathode active material toward the center thereof.

The predetermined depth T1 from the surface of the cathode active material may be a depth of more than 0 nm and 0.9 nm or less from the surface of the cathode active material toward the center thereof, or it may be a depth of 0.9 nm from the surface of the cathode active material toward the center thereof.

In the TEM-EDX analysis, the first surface layer has the first peak, may be free of the second peak, contains the element derived from the first peak, and may be free of the Mn element derived from the second peak.

The first surface layer may be free of the Ni element and the Co element.

The outermost surface of the first surface layer may be a point where the first peak is observed first when the TEM-EDX line analysis of the cathode active material is performed from the surface of the cathode active material toward the center thereof.

The second surface layer is the region between the predetermined depth T1 from the surface of the cathode active material and the predetermined depth T2 from the surface of the cathode active material. When the point of the predetermined depth T1 of the cathode active material corresponds to the first surface layer, the second surface layer does not include the point of the predetermined depth T1 of the cathode active material.

The predetermined depth T2 from the surface of the cathode active material may be a depth of 0.9 nm or more and 1.8 nm or less from the surface of the cathode active material toward the center thereof.

In the TEM-EDX analysis, the second surface layer has the first and second peaks which the peak intensity of the first peak is larger than that of the second peak and which the amount of the element derived from the first peak may be larger than that of the Mn element derived from the second peak. The ratio of the first peak intensity to the second peak intensity (the first peak intensity/second peak intensity ratio) may be from 1.1 to 2.0, or it may be from 1.1 to 1.2.

The second surface layer may contain at least one selected from the group consisting of the Ni element and the Co element.

The outermost surface of the second surface layer may be a point where the second peak is observed first and the peak intensity of the first peak is larger than that of the second peak when the TEM-EDX line analysis of the cathode active material is performed from the surface of the cathode active material toward the center thereof.

The first central layer is the region between the predetermined depth T2 from the surface and the predetermined depth T3 from the surface. When the point of the predetermined depth T2 of the cathode active material corresponds to the second surface layer, the first central layer does not include the point of the predetermined depth T2 of the cathode active material.

The predetermined depth T3 from the surface of the cathode active material may be a depth of 1.8 nm or more and 3.6 nm or less from the surface of the cathode active material toward the center thereof.

In the TEM-EDX analysis, the first central layer has the first and second peaks which the peak intensity of the second peak is larger than that of the first peak and which the amount of the element derived from the first peak may be smaller than that of the Mn element derived from the second peak. The ratio of the first peak intensity to the second peak intensity (the first peak intensity/second peak intensity ratio) may be from 0.5 to 0.9, or it may be from 0.5 to 0.6.

The first central layer may contain at least one selected from the group consisting of the Ni element and the Co element.

The outermost surface of the first central layer may be a point where the peak intensity of the second peak is larger than that of the first peak first when the TEM-EDX line analysis of the cathode active material is performed from the surface of the cathode active material toward the center thereof.

The second central layer is the region between the predetermined depth T3 from the surface of the cathode active material and the center. When the point of the predetermined depth T3 of the cathode active material corresponds to the first central layer, the second central layer does not include the point of the predetermined depth T3 of the cathode active material.

The predetermined depth T3 from the surface of the cathode active material may be a depth of 3.6 nm or more from the surface of the cathode active material toward the center thereof, or it may be a depth of 3.6 nm from the surface of the cathode active material toward the center thereof.

In the TEM-EDX analysis, the second central layer has the second peak, may be free of the first peak, contains the Mn element derived from the second peak, and may be free of the element derived from the first peak.

The second central layer may contain at least one selected from the group consisting of the Ni element and the Co element.

The outermost surface of the second central layer may be a point where the first peak is not observed first and the second peak is observed when the TEM-EDX line analysis of the cathode active material is performed from the surface of the cathode active material toward the center thereof.

The cathode active material is a cathode active material for a battery. The details of the battery will be described later.

The cathode active material may be particles.

The average particle diameter of the cathode active material particles may be 0.5 μm or more, 1 μm or more, or 2 μm or more, for example. The average particle diameter of the cathode active material particles may be 30 μm or less, 10 μm or less, 5 μm or less, or 3 μm or less, for example.

The cathode active material is only required to contain at least the Mn element derived from the second peak. The cathode active material may contain the element derived from the first peak. For example, it may contain Li, a transition metal (TM) and O. The cathode active material may be a lithium-transition metal composite oxide containing Li, a transition metal and O. The lithium-transition metal composite oxide is only required to contain at least Mn as the transition metal, and it may contain two transition metals, may contain three transition metals, or may contain 4 or more transition metals. As the transition metal, examples include, but are not limited to, Ti, V, Cr, Mn, Fe, Co, Ni, Zr and Nb.

As the transition metal, the lithium-transition metal composite oxide is only required to contain at least Mn. As the transition metal, it may further contain Co, Ni and so on.

In addition to the Li and the transition metal, the lithium-transition metal composite oxide may contain a metal M¹ which is a metal different from the Li and the transition metal and which may be a semimetal. As the different metal M¹, examples include, but are not limited to, Al, Si, Ga, Ge, In and Sn.

The lithium-transition metal composite oxide may contain Li, Ni, Co, Mn and O.

With respect to 1 mol that is the total of all the metals (excluding the Li) contained in the lithium-transition metal composite oxide, the total amount of the Ni, Co and Mn contained in the lithium-transition metal composite oxide is 0.80 mol or more, for example. The total amount may be 0.90 mol or more, may be 0.95 mol, or may be 1 mol. The total amount of the Ni, Co and Mn encompasses such a case, that the amount of the Ni and Co is 0.

The lithium-transition metal composite oxide may have a composition represented by the general formula LixNiaCobMncOy (where 0.1≤x≤1.5; 0.5≤a<1.0; 0≤b≤0.3; 0<c≤0.3; a+b+c=1.0; and 1.5≤y≤2.1).

In the general formula, the Li composition ratio “x” is only required to satisfy the relationship of 0.1≤x≤1.5. For example, the Li composition ratio “x” may be 0.4 or more, 0.6 or more, 0.8 or more, 1.0 or more, or 1.1 or more. For example, the Li composition ratio “x” may be 1.4 or less, or it may be 1.2 or less.

In the above general formula, the O composition ratio “y” is only required to satisfy the relationship of “1.5≤y≤2.1”. For example, the O composition ratio “y” may be 1.6 or more, 1.7 or more, 1.8 or more, or 1.9 or more. For example, the O composition ratio “y” may be 2.0 or less.

In the above general formula, the Ni composition ratio “a”, the Co composition ratio “b” and the Mn composition ratio “c” satisfy the relationship of “a+b+c=1.0”.

In the above general formula, the Ni composition ratio “a” is only required to satisfy the relationship of “0.5≤a<1.0”. For example, the Ni composition ratio “a” may be 0.6 or more, 0.7 or more, 0.8 or more, or 0.85 or more. For example, the Ni composition ratio “a” may be 0.9 or less.

In the above general formula, the Co composition ratio “b” is only required to satisfy the relationship of “0≤b≤0.3”. For example, the Co composition ratio “b” may be 0.01 or more, 0.02 or more, 0.03 or more, 0.04 or more, 0.05 or more, 0.06 or more, 0.07 or more, or 0.075 or more. For example, the Co composition ratio “b” may be 0.25 or less, 0.20 or less, 0.15 or less, 0.10 or less, 0.09 or less, or 0.08 or less.

In the above general formula, the Mn composition ratio “c” is only required to satisfy the relationship of “0<c≤0.3”. For example, the Mn composition ratio “c” may be 0.01 or more, 0.02 or more, 0.03 or more, 0.04 or more, 0.05 or more, 0.06 or more, 0.07 or more, or 0.075 or more. For example, the Mn composition ratio “c” may be 0.25 or less, 0.20 or less, 0.15 or less, 0.10 or less, 0.09 or less, or 0.08 or less.

A desired dopant may be added to the lithium-transition metal composite oxide. The dopant shows an element other than Li, Ni, Co, Mn and O. For example, the dopant may include at least one selected from the group consisting of Zr, Mo, Mg, Ca, Na, Fe, Cr, Zn, Si, Sn, Al and Ag. For example, the composition ratio “d” of the dopant may be 0.005 or more, 0.01 or more, 0.02 or more, 0.03 or more, or 0.04 or more, with respect to a+b+c=1.0. For example, the composition ratio “d” of the dopant may be 0.05 or less, with respect to a+b+c=1.0.

The lithium-transition metal composite oxide may be crystalline primary particle.

The lithium-transition metal composite oxide may be single-crystal type active material composed of the primary particle. The single-crystal type active material means that it is not a so-called polycrystal type active material (an active material composed of closely aggregated primary particles). That is, the single-crystal type active material may be a single-crystal particle. Compared to the polycrystal type active material, the single-crystal type active material has the advantage of less deterioration over time.

In a SEM image, the single-crystal type active material appears as one non-aggregated, independent particle (a primary particle). In a SEM image, the single-crystal type active material appears not to have a grain boundary. The magnification of the SEM image may be from 10,000× to 30,000×, for example.

The crystal structure of the lithium-transition metal composite oxide may be a layered rock salt structure. Also, the lithium-transition metal composite oxide may have a crystal structure belonging to space group R-3m.

The particle diameter of the primary particle that is the lithium-transition metal composite oxide may be 0.5 μm or more, may be 0.6 μm or more, may be 0.8 μm or more, or may be 1.0 μm or more. When the particle diameter of the primary particle is too small, there is a possibility that the particle is a poorly grown particle and has a difficulty in being produced as a single crystal. On the other hand, the particle diameter of the primary particle is 10 μm or less, for example. The particle diameter may be 5 μm or less, or it may be 3 μm or less. The particle diameter of the primary particle can be obtained as the longest diameter in a TEM or SEM image. For example, when the cathode layer contains the primary particle (the lithium-transition metal composite oxide), the particle diameter of the primary particle may be obtained from the longest diameter of the primary particle shown in a SEM cross-sectional image of the cathode layer. As used herein, the particle diameter of the primary particle is not the average particle diameter. That is, when the cathode layer contains a plurality of the primary particles, the particle diameter of the primary particle means the particle diameter of each primary particle.

### 2. Method for Producing the Cathode Active Material

According to the present disclosure, a method for producing the above-described cathode active material is provided, the method comprising:
a first sintering step of obtaining a precursor of the cathode active material by sintering a first mixture of a transition metal hydroxide and a lithium compound at a temperature of from 700° C. to 1100° C.,
a spray-drying step of obtaining a dried product by spray-drying a second mixture of the precursor of the cathode active material and Mn(NO₃)₂ with a spray dryer, and
a second sintering step of obtaining the cathode active material by sintering the dried product at a temperature of from 100° C. to 130° C.,
wherein the air inlet temperature of the spray dryer in the spray-drying step is from 100° C. to 130° C.

The cathode active material production method of the present disclosure includes (1) the first sintering step, (2) the spray-drying step and (3) the second sintering step.

### (1) First Sintering Step

The first sintering step is a step of obtaining a precursor of the cathode active material by sintering a first mixture of a transition metal hydroxide and a lithium compound at a temperature of from 700° C. to 1100° C.

The method for producing the transition metal hydroxide of the present disclosure is not particularly limited, and it may be the following method, for example.

First, the raw material aqueous solution of the transition metal hydroxide is prepared. As the method for producing the raw material aqueous solution, examples include, but are not limited to, dissolving a water-soluble transition metal compound in water. As the transition metal compound, examples include, but are not limited to, a metal salt such as sulfate salt and nitrate salt. As the Ni source, examples include, but are not limited to, NiSO₄ and Ni(NO₃)₂. As the Co source, examples include, but are not limited to, CoSO₄, Co(NO₃)₂ and Co(NO₃)₃. As the Mn source, examples include, but are not limited to, MnSO₄ and Mn(NO₃)₂. The composition of the raw material aqueous solution is appropriately adjusted depending on the target cathode active material.

Next, a certain amount of NH₃ aqueous solution is put in a reaction container. While stirring the NH₃ aqueous solution with a stirrer or the like, the atmosphere inside the reaction container is replaced with an unoxidized atmosphere by nitrogen purging. The nitrogen gas flow rate of the nitrogen purging is not particularly limited. For example, it may be from 2 L/min to 6 L/min.

Then, a sodium hydroxide aqueous solution is put in the reaction container. While keeping the pH of the sodium hydroxide aqueous solution alkaline (e.g., pH 11.3 to pH 12.0), the raw material aqueous solution and another NH₃ aqueous solution are added dropwise to the reaction container for 5 to 15 hours, thereby developing a reaction. The reaction temperature is not particularly limited. For example, it may be 50° C. or more and 65° C. or less.

After the end of the reaction, the reactant may be pre-sintered. It can be carried out at 120° C. to 220° C. for 4 to 10 hours at 0.2 MPa to 1.0 MPa, for example.

After the end of the reaction or after the end of the pre-sintering, a product thus obtained is washed with water and then filtered, thereby obtaining a transition metal hydroxide. The obtained transition metal hydroxide is subjected to a drying treatment. The drying treatment can be carried out at 110° C. for 10 to 12 hours, for example.

In the present disclosure, the transition metal hydroxide contains a transition metal. The transition metal hydroxide may be a nickel-cobalt-manganese composite hydroxide containing nickel (Ni), cobalt (Co) and manganese (Mn). In the nickel-cobalt-manganese composite hydroxide, the ratio (mole ratio) of each metal species to the total amount of the nickel, cobalt and manganese is the same as the composition ratio of the lithium-transition metal composite oxide represented by the above general formula in the cathode active material.

The lithium compound (the Li source) may be, for example, at least one selected from the group consisting of lithium carbonate, lithium nitrate, lithium acetate, lithium hydroxide, lithium oxide, lithium chloride and the like. The lithium compound may be lithium hydroxide. The mole ratio of the Li of the Li source to the TM contained in the transition metal hydroxide may be, for example, 0.4 or more, 0.6 or more, 0.8 or more, 1.0 or more, or 1.1 or more. It may be 1.4 or less or may be 1.2 or less.

The ratio between the lithium compound and transition metal hydroxide in the first mixture is adjusted so that the ratio (mole ratio) of the lithium and the different metal species to the total amount of the lithium in the target cathode active material and the metal species contained in the transition metal hydroxide, is typically equal to the ratio (mole ratio) of the lithium and different metal species in the first mixture. The method for mixing them is not particularly limited, and a known method may be employed.

The first mixture may contain molten salt. Since the molten salt functions as a flux, the primary particle can be sufficiently grown. The molten salt may contain Li. As the molten salt, examples include, but are not limited to, lithium hydroxide. The mole ratio (Li/TM) of the Li contained in the molten salt to the TM contained in the transition metal hydroxide is 0.01 or more, for example. It may be 0.05 or more, may be 0.10 or more, or may be 0.15 or more. On the other hand, the Li/TM ratio is 0.60 or less, for example. It may be 0.50 or less, may be 0.40 or less, or may be 0.30 or less.

As the Li source and the molten salt, the first mixture may contain lithium hydroxide. The mole ratio (Li′/TM) of the Li contained in the Li source and the molten salt to the TM contained in the transition metal hydroxide is 1.01 or more, for example. It may be 1.05 or more, may be 1.10 or more, or may be 1.15 or more. On the other hand, the Li′/TM ratio is 1.60 or less, for example. It may be 1.50 or less, may be 1.40 or less, or may be 1.30 or less.

The cathode active material that is the lithium-transition metal composite oxide is obtained by sintering the first mixture at a temperature of from 700° C. to 1100° C. for 8 to 15 hours, for example. To sinter the first mixture, a known furnace such as a muffle furnace can be used.

The lower limit of the sintering temperature of the first sintering step may be 800° C. or more, 850° C. or more, 900° C. or more, or 950° C. or more. On the other hand, the upper limit of the sintering temperature may be 1000° C. or less.

The sintering time of the first sintering step may be 9 hours or more, or it may be 10 hours or more.

The sintering time of the first sintering step may be 13 hours or less, or it may be 11 hours or less.

In general, the precursor of the cathode active material obtained by sintering the transition metal hydroxide of the present disclosure, is the single-crystal type active material composed of the primary particle.

### (2) Spray-Drying Step

The spray-drying step is a step of obtaining a dried product by spray-drying the second mixture of the precursor of the cathode active material and Mn(NO₃)₂ with a spray dryer.

The air inlet temperature of the spray dryer is from 100° C. to 130° C. By setting the air inlet temperature to a temperature is not more than the boiling point of the Mn(NO₃)₂, the surface of the lithium-transition metal composite oxide can be coated with the Mn(NO₃)₂.

The inlet air pressure of the spray dryer may be from 1.0 MPa to 3.0 MPa, or it may be 2.0 MPa. The nozzle pressure of the spray nozzle may be from 0.1 MPa to 0.3 MPa, or it may be 0.2 MPa.

The amount of the Mn(NO₃)₂ contained in the second mixture is not particularly limited. It may be from 1% by mass to 3% by mass, or it may be 1.6% by mass.

The second mixture contains at least the precursor of the cathode active material and the Mn(NO₃)₂. It may be a slurry obtained by adding the precursor of the cathode active material and the Mn(NO₃)₂ to a solvent and stirring the mixture. As the solvent used in the spray-drying step, examples include, but are not limited to, water and deionized water.

### (3) Second Sintering Step

The second sintering step is a step of obtaining the cathode active material by sintering the dried product at a temperature of from 100° C. to 130° C.

In the second sintering step, by sintering the dried product at a temperature of from 100° C. to 130° C., evaporation of the Mn(NO₃)₂ is suppressed, and the cathode active material containing the element derived from the first peak is obtained.

The sintering time of the second sintering step may be one hour or more, 9 hours or more, or 10 hours or more. On the other hand, the sintering time of the second sintering step may be 15 hours or less, 13 hours or less, or 11 hours or less.

### 3. Battery

The cathode active material provided by the present disclosure can be used as, for example, a cathode active material for forming the cathode of a battery such as a lithium ion battery. That is, in the present disclosure, a battery which a cathode, an electrolyte layer and an anode are stacked in this order and which the cathode contains the cathode active material of the present disclosure, is provided.

According to the present disclosure, by using the above-described cathode active material in the battery, the rate of resistance increase that is due to battery charge and discharge is decreased.

Hereinafter, the battery will be described in detail.

### [Cathode]

The cathode includes the cathode layer. As needed, it further includes a cathode collector.

The cathode layer is a layer which contains at least the above-described cathode active material of the present disclosure as the cathode active material.

The cathode layer may be disposed on one surface of the cathode collector, or it may be disposed on both surfaces of the cathode collector. The cathode may have a multi-layered structure by forming two or more cathode layers on at least one surface of the cathode collector. In the case of forming two or more cathode layers, the cathode active materials contained in the cathode layers may be the same type of cathode active material, or they may be different types of cathode active materials.

The cathode active material used in the cathode layer may contain only the cathode active material of the present disclosure, or it may further contain a different active material. As needed, the cathode layer may contain at least one selected from the group consisting of an electrolyte, an electroconductive material and a binder.

For example, the mixing ratio (mass ratio) between the cathode active material of the present disclosure and the different active material may be as follows: “the cathode active material of the present disclosure/the different active material=9.5/0.5 to 0.5/9.5”, “the cathode active material of the present disclosure/the different active material=9/1 to 1/9”, “the cathode active material of the present disclosure/the different active material=8/2 to 2/8”, “the cathode active material of the present disclosure/the different active material=7/3 to 3/7” or “the cathode active material of the present disclosure/the different active material=6/4 to 4/6”. The different active material may be a polycrystal type active material (polycrystal particles) composed of the secondary particles that are the above-described lithium-transition metal composite oxide. Also, the different active material may be, for example, lithium iron phosphate (olivine structure), lithium manganese phosphate (olivine structure), manganese iron phosphate (olivine structure), LiMnO₂ (rock salt structure), Li(NiMn)₂O₄ (spinel structure), LiCoO₂ (layered structure) or the like.

The percentage of the cathode active material in the cathode layer is 20% by mass or more, for example. It may be 30% by mass or more, or it may be 40% by mass or more. When the percentage of the cathode active material is too small, there is a possibility that a sufficient energy density is not obtained. On the other hand, the percentage of the cathode active material in the cathode layer is 95% by mass or less, for example. It may be 70% by mass or less, or it may be 60% by mass or less. When the percentage of the cathode active material is too large, the ion conductivity and electron conductivity of the cathode layer may relatively decrease.

As the electrolyte, examples include, but are not limited to, a solid electrolyte. The solid electrolyte may be an inorganic solid electrolyte such as a sulfide solid electrolyte, a halide solid electrolyte, an oxide solid electrolyte and a complex hydride solid electrolyte, or it may be an organic solid electrolyte such as a gel electrolyte.

The sulfide solid electrolyte is an electrolyte which contains a S element. In general, the sulfide solid electrolyte contains at least a Li element and a S element. The sulfide solid electrolyte may further contain a M element (M is at least one selected from the group consisting of P, As, Sb, Si, Ge, Sn, B, Al, Ga and In). Also, the sulfide solid electrolyte may contain a halogen element such as F, Cl, Br and I.

The sulfide solid electrolyte may be a glass-based (amorphous) sulfide solid electrolyte, may be a glass-ceramic-based sulfide solid electrolyte, or may be a crystal-based sulfide solid electrolyte. The sulfide solid electrolyte may have a crystal phase. As the crystal phase, examples include, but are not limited to, a Thio-LISICON-type crystal phase, an argyrodite-type crystal phase and a LGPS-type crystal phase.

The composition of the sulfide solid electrolyte is not particularly limited. As the composition, examples include, but are not limited to, xLi₂S·(1−x)P₂S₅ (where 0.5≤x<1) and yLiI·zLiBr·(100−y−z)(xLi₂S·(1−x)P₂S₅) (where 0.5≤x<1, 0≤y≤30 and 0≤z≤30). In these compositions, x may satisfy 0.7≤x≤0.8. Another example of the composition of the sulfide solid electrolyte is Li₇₋ₓPS₆₋ₓXₓ (where X is at least one selected from the group consisting of F, Cl, Br and I, and x satisfies 0≤x<2). Another example of the composition of the sulfide solid electrolyte is Li₄₋ₓMe₁₋ₓPₓS₄ (where 0<x<1 and Me is at least one selected from the group consisting of Al, Zn, In, Ge, Si, Sn, Sb, Ga and Bi). As the sulfide solid electrolyte, examples include, but are not limited to, LiI—LiBr—Li₂S—P₂S₅, LiI—Li₂S—P₂S₅, LiI—Li₂S—P₂O₅ and LiI—Li₃PO₄—P₂S₅.

As the oxide solid electrolyte, examples include, but are not limited to, a substance having a garnet-type crystal structure containing a Li element, La element, an A element (A is at least one selected from the group consisting of Zr, Nb, Ta and Al) and an O element. For example, the oxide solid electrolyte may be Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, Li₃₊ₓPO₄₋ₓNₓ (where 1≤x≤3) or the like.

For example, the halide solid electrolyte may be a solid electrolyte containing Li, D and X (D is at least one selected from the group consisting of Ti, Al and Y, and X is F, Cl or Br).

The gel electrolyte may contain an electrolytic solution and a polymer material. The polymer material may be a material forming a polymer matrix. For example, the polymer material may contain at least one selected from the group consisting of polyvinylidene fluoride (PVdF), poly(vinylidene fluoride-co-hexafluoropropylene) (PVDF-HFP), polyacrylonitrile (PAN), PVdF-PAN, polyethylene oxide (PEO), polyethylene glycol (PEG) and derivatives thereof.

The form of the solid electrolyte may be a particulate form, from the viewpoint of good handleability.

The average particle diameter of the solid electrolyte particles is not particularly limited. It may be from 1 nm to 100 μm.

The percentage of the solid electrolyte in the cathode layer may be 18 by mass or more, for example. When the percentage of the solid electrolyte is too small, the cathode layer may have a shortage of ion conducting paths. On the other hand, the percentage of the solid electrolyte in the cathode layer may be 60% by mass or less, for example. When the percentage of the solid electrolyte is too large, the percentage of the cathode active material is relatively small, and a low energy density may be obtained.

The cathode layer may contain an electroconductive material. The electron conductivity of the cathode layer is increased by adding the electroconductive material. As the electroconductive material, examples include, but are not limited to, a carbonaceous electroconductive material, metal particles and an electroconductive polymer. As the carbonaceous electroconductive material, examples include, but are not limited to, a particulate material such as Acetylene Black (AB) and Ketjen Black (KB) and a fibrous material such as vapor-grown carbon fiber (VGCF), carbon nanotube (CNT) and carbon nanofiber (CNF).

The percentage of the electroconductive material in the cathode layer may be 0.18 by mass or more, for example. When the percentage of the electroconductive material is too small, the cathode layer may have a shortage of electron conducting paths. On the other hand, the percentage of the electroconductive material in the cathode layer may be 5% by mass less, for example. When the percentage of the electroconductive material is too large, the percentage of the cathode active material is relatively small, and a low energy density may be obtained.

The cathode layer may contain a binder. As the binder, examples include, but are not limited to, styrene-butadiene rubber (SBR), polyimide (PI), polyacrylic acid (PAA), acrylonitrile-butadiene rubber (NBR), butadiene rubber (BR), polyvinylidene fluoride (PVdF), polytetrafluoroethylene (PTFE), a styrene-isoprene-styrene block copolymer (SIS) and an ethylene-propylene-diene copolymer (EPDM).

The percentage of the binder in the cathode layer may be 0.5% by mass or more, for example. When the percentage of the binder is too small, there is a possibility that an increase in resistance which is due to charge and discharge, cannot be sufficiently reduced. On the other hand, the percentage of the binder in the cathode layer may be 15% by mass or less, for example. When the percentage of the binder is too large, the percentage of the cathode active material is relatively small, and a low energy density may be obtained.

The thickness of the cathode layer is 0.1 μm or more and 1000 μm or less, for example. The thickness of the cathode layer may be 1 μm or more and 500 μm or less, or it may be 30 μm or more and 100 μm or less.

The method for producing the cathode layer is not particularly limited. For example, the production method may be a method including the steps of obtaining a cathode slurry by mixing the cathode active material, the electroconductive material and a solvent, applying the cathode slurry to a cathode collector and drying the applied slurry, thereby forming the cathode layer. To form the cathode layer, a press treatment (pressing the cathode layer in the thickness direction) may be performed. As the press treatment, examples include, but are not limited to, roller pressing and plate pressing.

As the solvent, examples include, but are not limited to, N-methylpyrrolidone (NMP), tetralin, diisobutyl ketone, butyl butyrate, mesitylene, heptane, dibutyl ether, decane, dodecane, isodecane and toluene. The solvent may contain two or more selected from these components.

As the material for the cathode collector, examples include, but are not limited to, SUS, Cr, Au, Pt, Zn, aluminum, copper, nickel, iron, titanium and carbon. The thickness of the cathode collector is 0.1 μm or more and 100 μm or less, for example. The form of the cathode collector may be a foil form, a plate form or the like. The plan view shape of the cathode collector is not particularly limited. As the shape, examples include, but are not limited to, a circular shape, an elliptical a rectangular shape and any polygonal shape. The structure of the cathode collector may be such that a buffer layer, an elastic layer or a positive temperature coefficient (PTC) thermistor layer is disposed on the surface.

### [Anode]

The anode includes the anode layer. As needed, it further includes an anode collector.

The anode layer is a layer containing at least an anode active material. As needed, the anode layer may contain at least one selected from the group consisting of an electrolyte, an electroconductive material and a binder. The area of the anode layer may be large compared to the cathode layer.

The anode active material may be in a particulate form or a sheet form, for example. The average particle diameter of the particles of the anode active material may be 1 μm or more, for example. The average particle diameter of the particles of the anode active material may be 30 μm or less, for example.

The anode active material may contain, for example, at least one selected from the group consisting of a carbon-based active material, a Li-based active material, a Si-based active material, a Si—C composite material and lithium titanate.

The carbon-based active material may contain, for example, at least one selected from the group consisting of graphite, soft carbon and hard carbon. The graphite is a general term for natural graphite and artificial graphite. The graphite may be a mixture of natural graphite and artificial graphite. For example, the mixing ratio (mass ratio) between the natural graphite and the artificial graphite may be as follows: “the natural graphite/the artificial graphite=1/9 to 9/1” or “the natural graphite/the artificial graphite=3/7 to 7/3”.

As the Li-based active material, examples include, but are not limited to, Li, Li silicate and Li alloy.

As the Si-based active material, examples include, but are not limited to, Si, SiO and Si alloy.

The Si—C composite material indicates a composite material composed of a carbon-based active material (such as graphite) and a Si-based active material (such as Si). For example, fine Si particles may be dispersed in a carbon particle. For example, a Li silicate particle may be coated with a carbonaceous material (such as amorphous carbon).

As the electrolyte, electroconductive material and binder used in the anode layer, examples include, but are not limited to, those exemplified above as the electrolyte, electroconductive material and binder used in the cathode layer.

As needed, the anode layer may contain a thickener. As the thickener, examples include, but are not limited to, carboxymethyl cellulose (CMC).

As the material for the anode collector, examples include, but are not limited to, SUS, aluminum, copper, nickel, iron, titanium and carbon. The thickness of the anode collector varies depending on the form. For example, the thickness may be in a range of from 1 μm to 50 μm. The form of the anode collector may be a foil form, a plate form or the like. The plan view shape of the anode collector is not particularly limited. As the shape, examples include, but are not limited to, a circular shape, an elliptical shape, a rectangular shape and any polygonal shape. The structure of the anode collector may be such that a buffer layer, an elastic layer or a PTC thermistor layer is disposed on the surface.

### [Electrolyte Layer]

The electrolyte layer is a layer formed between the cathode layer and the anode layer, and it contains at least an electrolyte. The electrolyte may be a solid electrolyte or a liquid electrolyte (an electrolytic solution).

The electrolyte layer may contain a solid electrolyte, an electrolytic solution and so on.

As the solid electrolyte, examples include, but are not limited to, those exemplified above as the solid electrolyte of the cathode layer.

As the electrolytic solution, an aqueous electrolytic solution, a non-aqueous electrolytic solution or the like can be used. They may be used alone or in combination of two or more.

The solvent of the aqueous electrolytic solution contains water as a main component. That is, when the whole amount of the solvent (a liquid component) constituting the electrolytic solution is determined as a reference (100% by mole), the water may account for 50% by mole or more, 70% by mole or more, or 90% by mole or more thereof. On the other hand, the upper limit of the proportion of the water in the solvent is not particularly limited.

While the solvent contains water as the main component, it may contain a solvent other than water. As the solvent other than water, examples include, but are not limited to, one or more selected from the group consisting of an ether, a carbonate, a nitrile, an alcohol, a ketone, an amine, an amide, a sulfur compound and a hydrocarbon. When the whole amount of the solvent (the liquid component) constituting the electrolytic solution is determined as a reference (100% by mole), the solvent other than water may be 50% by mole or less, may be 30% by mole or less, or may be 10% by mole or less.

The aqueous electrolytic solution used in the present disclosure contains an electrolyte. The electrolyte for the aqueous electrolytic solution may be selected from conventionally known electrolytes. As the electrolyte, examples include, but are not limited to, lithium salt, nitrate salt, acetate salt and sulfate salt of imidic acid compounds. More specifically, examples include, but are not limited to, lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(nonafluorobutanesulfonyl)imide, lithium nonafluoro-N-[(trifluoromethane)sulfonyl]butanesulfonylamide, lithium N, N-hexafluoro-1,3-disulfonylimide, CH₃COOLi, LiPF₆, LiBF₄, Li₂SO₄ and LiNO₃.

The concentration of the electrolyte in the aqueous electrolytic solution can be appropriately determined depending on desired battery properties, as long as the concentration does not exceed the saturation concentration of the electrolyte with respect to the solvent. This is because, when the electrolyte remains in a solid form in the aqueous electrolytic solution, the solid electrolyte may interfere with battery reaction.

For example, in the case of using LiTFSI as the electrolyte, the amount of the LiTFSI contained in the aqueous electrolytic solution may be 1 mol or more, 5 mol or more, or 7.5 mol or more per kg of the water. The upper limit of the amount is not particularly limited, and it may be 25 mol or less, for example.

As the non-aqueous electrolytic solution, one containing a lithium salt and a non-aqueous solvent is generally used.

As the lithium salt, examples include, but are not limited to, an inorganic lithium salt such as LiPF₆, LiBF₄, LiClO₄ and LiAsF₆, such and an organic lithium salt as LiCF₃SO₃, LiN(SO₂CF₃)₂ (Li-TFSI), LiN(SO₂C₂F₅)₂ and LiC(SO₂CF₃)₃.

As the non-aqueous solvent, examples include, but are not limited to, ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethylsulfoxide (DMSO) and mixtures thereof. From the viewpoint of obtaining high dielectric constant and low viscosity, the non-aqueous solvent may be a mixture of a cyclic carbonate compound having high dielectric constant and high viscosity (such as EC, PC and BC) and a chain carbonate compound having low dielectric constant and low viscosity (such as DMC, DEC and EMC), or it may be a mixture of EC and DEC.

The concentration of the lithium salt in the non-aqueous electrolytic solution may be from 0.3 M to 5 M, for example.

The non-aqueous electrolytic solution may contain an ionic liquid. The ionic liquid may contain, for example, at least one selected from the group consisting of sulfonium salt, ammonium salt, pyridinium salt, piperidinium salt, pyrrolidinium salt, morpholinium salt, phosphonium salt, imidazolium salt and derivatives thereof.

As the electrolyte layer, a separator which is impregnated with the above-mentioned electrolytic solution and is configured to prevent contact between the cathode layer and the anode layer, may be used.

The material for the separator is not particularly limited, as long as it is a porous film. As the material, examples: but are not limited to, resins such as polyethylene (PE), polypropylene (PP), polyester, polyvinyl alcohol, cellulose and polyamide. Of them, the material for the separator may be polyethylene or polypropylene. The separator may have a single-layered structure or a multi-layered structure. As the separator having a multi-layered structure, examples include, but are not limited to, a separator having a two-layered structure such as PE/PP, and a separator having a three-layered structure such as PP/PE/PP and PE/PP/PE.

The separator may be a non-woven fabric such as a resin non-woven fabric and a glass fiber non-woven fabric.

### [Solid Electrolyte Layer]

The electrolyte layer may be a solid electrolyte layer composed of a solid.

When the electrolyte layer is the solid electrolyte layer, the solid electrolyte layer contains a solid electrolyte. As needed, it contains a binder and so on.

As the solid electrolyte, examples include, but are not limited to, those exemplified above as the solid electrolyte of the cathode layer.

The solid electrolyte may be one solid electrolyte, or it may be two or more solid electrolytes. In the case of using two or more solid electrolytes, they may be mixed together, or they may be formed into layers to obtain a multi-layered structure.

The amount of the solid electrolyte in the solid electrolyte layer is not particularly limited. For example, it may be 50% by mass or more; it may be in a range of 608 by mass or more and 100% by mass or less; it may be in a range of 70% by mass or more and 100% by mass or less; or it may be 100% by mass. The electrolytic solution contained in the solid electrolyte layer may be less than 1% by mass with respect to the total amount of the solid electrolyte layer.

As the binder, examples include, but are not limited to, a binder that can be incorporated in the above-described cathode layer.

The content of the binder in the solid electrolyte layer may be from 0% by mass to 10% by mass with respect to the total amount of the solid electrolyte layer.

The thickness of the electrolyte layer is 0.1 μm or more and 1000 μm or less, for example. The thickness of the electrolyte layer may be 0.1 μm or more and 500 μm or less, or it may be 0.1 μm or more and 100 μm or less.

In the present disclosure, the battery may further include a fixing jig for applying a fixing pressure to the cathode layer, the electrolyte layer and the anode layer along the thickness direction. Especially when the electrolyte layer is the solid electrolyte layer, the fixing pressure may be applied for the formation of good ion conducting paths and electron conducting paths. The fixing pressure is 0.1 MPa or more, for example. The fixing pressure may be 1 MPa or more, or it may be 5 MPa or more. On the other hand, the fixing pressure is 100 MPa or less, for example. The fixing pressure may be 50 MPa or less, or it may be 20 MPa or less.

### [Battery]

In the present disclosure, the type of the battery is not particularly limited. The battery of the present disclosure is typically a lithium ion battery. Also in the present disclosure, the battery may be a liquid battery in which the electrolyte layer contains an electrolytic solution, or it may be a solid-state battery in which the electrolyte layer contains a solid electrolyte. The solid-state battery may be a semi-solid-state battery or an all-solid-state battery. In the present disclosure, the semi-solid-state battery is a battery in which the electrolyte layer contains a solid component (such as an inorganic solid electrolyte) and a liquid component (such as a solvent and an electrolytic solution). In the present disclosure, the all-solid-state battery is a battery in which the electrolyte layer contains, as the electrolyte, only a solid component such as an inorganic solid electrolyte. In the present disclosure, the battery may be a primary battery or a secondary battery. Among them, the solid-state battery may be a secondary battery. This is because a secondary battery can be repeatedly charged and discharged, and it is useful as an in-vehicle battery, for example.

The form of the battery is not particularly limited. For example, it may be a coin form, a cylindrical form, a square form, a sheet form, a button form, a flat form or a laminate form.

When the battery is a cell stack consisting of stacked cells, the cell stack may be a monopolar cell stack or a bipolar cell stack.

As the applications of the battery, examples include, but are not limited to, the power source of vehicles such as a hybrid electric vehicle (HEV), a plug-in hybrid electric vehicle (PHEV), a battery electric vehicle (BEV), a gasoline vehicle and a diesel vehicle. Especially, the battery of the present disclosure may be used as the driving power supply of a hybrid electric vehicle (HEV), a plug-in hybrid electric vehicle (PHEV) or a battery electric vehicle (BEV). Also, the battery of the present disclosure may be used as the powder source of mobile objects other than vehicles, such as railroads, ships and aircraft, or it may be used as the power source of electrical appliances such as information processing devices.

The present disclosure is not limited to the above-mentioned embodiments. The above-mentioned embodiments are examples, and any that has the substantially same essential features as the technical ideas described in the claims of the present disclosure and exerts the same effects and advantages as the embodiments is included in the technical scope of the present disclosure.

### EXAMPLES

### Example 1

### [Synthesis of the Transition Metal Hydroxide]

First, NiSO₄, CoSO₄ and MnSO₄ were dissolved in deionized water to prepare a raw material aqueous solution. The ratio between the Ni, Co and Mn in the raw material aqueous solution was Ni:Co:Mn=80:10:10. The concentration of the raw material aqueous solution (the ratio of all the raw materials to the raw material aqueous solution) was 30% by mass.

### <Hydrothermal Synthesis (Crystallization)>

A certain amount of NH₃ aqueous solution was put in a reaction container. While stirring the NH₃ aqueous solution with a stirrer, the atmosphere inside the reaction container was replaced with nitrogen. Then, a NaOH aqueous solution was put in the reaction container. While keeping the pH of the NaOH aqueous solution alkaline (pH 12) and controlling the temperature thereof at a certain temperature, the raw material aqueous solution and another NH₃ aqueous solution were added dropwise to the reaction container, thereby precipitating a transition metal hydroxide. The reaction temperature was 60° C., and the reaction time was 10 hours.

### <Filtering>

After the hydrothermal synthesis, the transition metal hydroxide was dispersed in and washed with deionized water. Then, the washed transition metal hydroxide was filtered to obtain the transition metal hydroxide.

### <Drying>

The obtained transition metal hydroxide was a dried at 120° C. for 16 hours for water evaporation.

### [Synthesis of the Cathode Active Material]

<Mixing with Li Raw Material>

Using an agate mortar, the dried transition metal hydroxide was mixed with LiOH that was a lithium compound as the Li source, thereby obtaining a mixture.

They were mixed so that the mole ratio (Li/NCM ratio) of the lithium compound to the total (NCM) of the Ni, Co and Mn contained in the transition metal hydroxide, was adjusted to 1.1.

### <First Sintering>

Using a furnace, the obtained mixture was sintered in an oxygen atmosphere at 1000° C. for 10 hours, thereby synthesizing a cathode active material (Li_{1.1}Ni_{0.8}Co_{0.1}Mn_{0.1}O₂), i.e., obtaining the first sintered product.

<First Grinding>

Using a grinding mill that was a jet mill, the first sintered product was ground to a predetermined particle diameter.

<Spray-Drying>

First, 100 ml of deionized water and 0.5 g of Mn(NO₃)₂ were put in a beaker. While stirring the mixture, 30 g of the first sintered product was added thereto, thereby obtaining a slurry. The obtained slurry was spray-dried by a spray dryer, thereby obtaining a dried product. The air inlet temperature of the spray dryer was 130° C., and the inlet air pressure was 2.0 MPa. The nozzle pressure of the spray nozzle was 0.2 MPa.

### <Second Sintering>

Using the furnace, the obtained dried product was sintered in an oxygen atmosphere at 100° C. for 10 hours, thereby obtaining the second sintered product that was the cathode active material.

### <Second Grinding>

Using the grinding mill (the jet mill), the second sintered product (the cathode active material) was ground to a predetermined particle diameter, thereby obtaining the particles of the cathode active material.

### Example 2

The cathode active material of Example 2 was produced in the same manner as Example 1, except that the air inlet temperature of the spray dryer was 100° C. in the above-described <Spray-drying>.

### Comparative Example 1

The cathode active material of Comparative Example 1 was produced in the same manner as Example 1, except that the <Spray-drying>, the <Second sintering> and the <Second grinding> were not carried out in the [Synthesis of the cathode active material], and the particles of the first sintered product obtained in the <First grinding> of the [Synthesis of the cathode active material] were used as the cathode active material.

### Comparative Example 2

The cathode active material of Comparative Example 2 was produced in the same manner as Example 1, except that the air inlet temperature of the spray dryer was 200° C. in the <Spray-drying>.

### [TEM-EDX Analysis]

The following results were obtained by TEM-EDX line analysis of the cathode active material of Examples 1 and 2 and Comparative Examples 1 and 2.

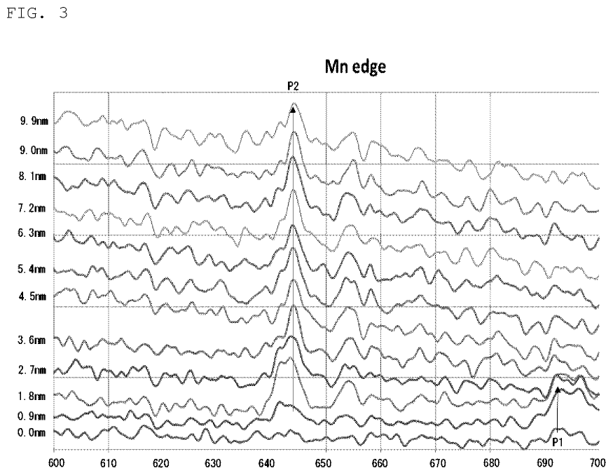

FIG. 3 shows a spectrum of the cathode active material of Example 1 obtained by TEM-EDX. As shown in FIG. 3, P1 is the first peak, and P2 is the second peak.

As a result of observing the cathode active materials of Examples 1 and 2 by TEM-EDX, the first peak was observed in a range of 690 ev or more and 700 ev or less and in the region between the surface of the cathode active material particles and a depth of 2.7 nm from the surface of the particles toward the center thereof, and the second peak was observed in a range of 640 ev or more and 650 ev or less and in the region between a depth of 0.9 nm from the surface of the particles toward the center thereof and the center. Accordingly, the cathode active materials of Examples 1 and 2 were confirmed to have the surface layer which the intensity of the first peak was larger than that of the second peak and the central layer which the intensity of the first peak was smaller than that of the second peak.

As a result of observing the cathode active material of Comparative Example 1 by TEM-EDX, the first peak was not observed in a range of 690 ev or more and 700 ev or less, and the second peak was observed in a range of 640 ev or more and 650 ev or less and in all the regions of the cathode active material particles.

As a result of observing the cathode active material of Comparative Example 2 by TEM-EDX, the first peak was not observed in a range of 690 ev or more and 700 ev or less, and the second peak was observed in a range of 640 ev or more and 650 ev or less and in all the regions of the cathode active material particles. It is though that since, in Comparative Example 2, the air inlet temperature of the spray dryer was set higher than the boiling point (130° C.) of the Mn(NO₃)₂, the Mn(NO₃)₂ was vaporized, and the coating layer containing the element derived from the first peak was not formed.

### [Production of Cells (Wound Cylindrical Cells)]

The wound cylindrical cell of Example 1 was produced as follows by use of the cathode active material of Example 1.

First, a cathode mixture paste containing the cathode active material, Acetylene Black (an electroconductive material) and polyvinylidene fluoride (a binder) was applied to a surface of a metal foil (a cathode collector) by a film applicator with film thickness adjustability (manufactured by Allgood Co., Ltd.) Then, the applied paste was dried by a dryer at 80° C. for 5 minutes to form a cathode layer on the cathode collector, thereby producing a cathode. The composition of the cathode mixture paste was such that the cathode active material, the electroconductive material and the binder were in a mass ratio of 88:10:2.

Next, an anode mixture paste containing natural graphite (an anode active material), SBR (a binder) and CMC (a thickener) was applied to a surface of a metal foil (an anode collector) by a film applicator with film thickness adjustability (manufactured by Allgood Co., Ltd.) Then, the applied paste was dried by a dryer at 80° C. for 5 minutes to form an anode layer on the anode collector, thereby producing an anode.

As an electrolytic solution, a 1 M LiPF₆ solution was prepared, which contained an electrolyte that was LiPF₆ and a solvent that was a mixture of ethylene carbonate (EC), dimethyl carbonate (DMC) and ethyl methyl carbonate (EMC) at a volume ratio of EC/DMC/EMC=3/4/3.

The cathode, a separator and the anode were stacked, and the separator was impregnated with the electrolytic solution, thereby producing the wound cylindrical cell of Example 1. In the same manner as Example 1, the wound cylindrical cells of Example 2 and Comparative Examples 1 and 2 were also produced.

### [Cell Evaluation]

The produced wound cylindrical cells were evaluated for IV resistance before and after a cycle test of 100 cycles. The 100 cycles of the cycle test were conducted in the following conditions.

### <Cycling Conditions>

Voltage range: 3.0 V to 4.3 V
C rate: 0.3 C
Mode: CC charge and discharge
Temperature: 50° C.

### [IV Resistance Measurement]

Cell voltage was adjusted in a voltage range of from 3.0 V to 4.3 V to achieve a SOC of 50%, while considering the upper limit voltage of 4.3 V as a SOC of 100%.

Cell voltage drop (V) was measured at C rates of 0.1 C, 0.3 C, 0.5 C, 0.7 C and 1.0 C, when the cell was discharged for 10 seconds at 0° C.

The relationship between the current value and voltage drop (V) of the cell was plotted, and the slope of an approximate straight line created by a linear function was considered as IV resistance.

[Calculation of IV Resistance Increase Rate after the 100 Cycles]

The above-described measurement was carried out before and after the cycle test of the 100 cycles. The amount of change before and after the cycle test was calculated and used as the resistance increase rate.

$$IV resistance increase rate ( \% ) after the 100 cycles = ( IV resistance after the cycle test ) / ( IV resistance before the cycle test ) \times 100$$

### [Measurement of Eluted Mn Amount]

After the cycle test, each cell was disassembled to obtain the anode layer. By ICP-MS measurement of the obtained anode layer, the amount of the Mn with respect to 1 mg that was the weight of the anode layer used for the measurement, was measured. The results are shown in Table 1.

With respect to 1 mg that was the weight of the anode layer used for the measurement, the amount of the Mn was 1200 ppm/mg in Comparative Example 1, 1150 ppm/mg in Comparative Example 2, 812 ppm/mg in Example 1, and 724 ppm/mg in Example 2. The amount of the Mn contained in the anode layer was considered to be the amount of the Mn eluted from the cathode active material of the cathode layer. It was revealed that the amount of the Mn eluted from the cathode layer was reduced in the batteries using the cathode active materials of Examples 1 and 2, compared to the batteries using the cathode active materials of Comparative Examples 1 and 2.

TABLE 1

| | Li/NCM | Ni/NCM | Co/NCM | Mn/NCM | | | | | Mn amount |
|---|---|---|---|---|---|---|---|---|---|
| | ratio of | ratio of | ratio of | ratio of | | | | Resistance | (ppm/mg) in |
| | the | the | the | the | Spray- | | | increase | the anode |
| | cathode | cathode | cathode | cathode | drying | | | rate (%) | layer after |
| | active | active | active | active | temperature | First | Second | after the | the 100 |
| | material | material | material | material | (° C.) | peak | peak | 100 cycles | cycles |
| Comparative | 1.1 | 0.8 | 0.1 | 0.1 | — | Absent | Present | 150 | 1200 |
| Example 1 | | | | | | | | | |
| Comparative | 1.1 | 0.8 | 0.1 | 0.1 | 200 | Absent | Present | 148 | 1150 |
| Example 2 | | | | | | | | | |
| Example 1 | 1.1 | 0.8 | 0.1 | 0.1 | 130 | Present | Present | 132 | 812 |
| Example 2 | 1.1 | 0.8 | 0.1 | 0.1 | 100 | Present | Present | 128 | 724 |

Based on the results shown in Table 1, the following comparison was made.

As is clear from Table 1, the resistance increase rates after the 100 cycles of the batteries using the cathode active materials of Examples 1 and 2, are small compared to those of the batteries using the cathode active materials of Comparative Examples 1 and 2. Accordingly, it is revealed that the resistance increase rate due to battery charge and discharge is decreased by containing the element derived from the first peak especially on the surface layer side of the cathode active material.

### REFERENCE SIGNS LIST

10. Surface layer
11. First surface layer
12. Second surface layer
20. Central layer
21. First central layer
22. Second central layer
100. Cathode active material
200. Cathode active material

1. A cathode active material,
wherein, in TEM-EDX analysis, the cathode active material has a first peak in a range of 690 ev or more and 700 ev or less and a second peak in a range of 640 ev or more and 650 ev or less, and
wherein the cathode active material comprises a Mn element that is derived from the second peak.

2. The cathode active material according to claim 1,
wherein, when a region between a surface of the cathode active material and a predetermined depth T from the surface of the cathode active material toward a center thereof, is considered as a surface layer, and a region between the predetermined depth T and the center is considered as a central layer,
in the TEM-EDX analysis, the surface layer has the first and second peaks which a peak intensity of the first peak is larger than that of the second peak and which an amount of an element derived from the first peak is larger than that of the Mn element derived from the second peak, and
in the TEM-EDX analysis, the central layer has the first and second peaks which the peak intensity of the second peak is larger than that of the first peak and which the amount of the Mn element derived from the second peak is larger than that of the element derived from the first peak.

3. The cathode active material according to claim 1,
wherein, when a region between a surface of the cathode active material and a predetermined depth T from the surface of the cathode active material toward a center thereof, is considered as a surface layer, and a region between the predetermined depth T and the center is considered as a central layer,
in the TEM-EDX analysis, the surface layer has the first peak, is free of the second peak and is free of the Mn element derived from the second peak, and
in the TEM-EDX analysis, the central layer has the second peak, is free of the first peak and is free of an element derived from the first peak.

4. The cathode active material according to claim 1,
wherein, when a region between a surface of the cathode active material and a predetermined depth T1 from the surface of the cathode active material toward a center thereof, a region between the predetermined depth T1 and a predetermined depth T2, a region between the predetermined depth T2 and a predetermined depth T3, and a region between the predetermined depth T3 and the center are considered as a first surface layer, a second surface layer, a first central layer and a second central layer, respectively,
in the TEM-EDX analysis, the first surface layer has the first peak, is free of the second peak and is free of the Mn element derived from the second peak,
in the TEM-EDX analysis, the second surface layer has the first and second peaks which a peak intensity of the first peak is larger than that of the second peak and which an amount of an element derived from the first peak is larger than that of the Mn element derived from the second peak,
in the TEM-EDX analysis, the first central layer has the first and second peaks which the peak intensity of the second peak is larger than that of the first peak and which the amount of the Mn element derived from the second peak is larger than that of the element derived from the first peak, and
in the TEM-EDX analysis, the second central layer has the second peak, is free of the first peak and is free of the element derived from the first peak.

5. The cathode active material according to claim 1, further comprising a Li element, a Ni element and a Co element.

6. The cathode active material according to claim 5, wherein a content of the Mn in the cathode active material is 0.1 mol with respect to 1 mol that is a total of the Ni, Co and Mn contained in the cathode active material.

7. A cathode layer comprising the cathode active material defined by claim 1.

8. A battery comprising a cathode layer comprising the cathode active material defined by claim 1.

9. A method for producing the cathode active material defined by claim 1, the method comprising:
a first sintering step of obtaining a precursor of the cathode active material by sintering a first mixture of a transition metal hydroxide and a lithium compound at a temperature of from 700° C. to 1100° C.,
a spray-drying step of obtaining a dried product by spray-drying a second mixture of the precursor of the cathode active material and Mn(NO₃)₂ with a spray dryer, and
a second sintering step of obtaining the cathode active material by sintering the dried product at a temperature of from 100° C. to 130° C.,
wherein an air inlet temperature of the spray dryer in the spray-drying step is from 100° C. to 130° C.
